(19) United States
(12) Patent Application Publication
(10) Pub. No.: US 2012/0152689 A1
(43) Pub. Date: Jun. 21, 2012

(54) SLIDE ASSEMBLY WITH CURVED SLOPE SURFACE

(76) Inventor: SHIH-CHOU WEN, Sanchong City (TW)

(21) Appl. No.: 12/969,604

(22) Filed: Dec. 16, 2010

(51) Int. Cl. F16D 15/00

(52) U.S. Cl. 192/107 T

(57) ABSTRACT

A slide assembly includes a slide block received in a clutching channel of a driven member. The slide block forms at least one notch, which forms a curved slope surface and movably receives a roll therein. The curved slope surface has a curvature substantially identical to a curvature of a curved surface of the clutching channel. The curved slope surface forms an included angle with respect to the curved surface and defines an obtuse corner portion. The roll is biased by an elastic basing member toward the obtuse corner portion. The slide block has a side surface to which a bar is mounted, and the bar carries a roller, which is movably received in a slot defined in a driving disc. The curved slope surface allows the roll to maintain a constant friction pressure angle with respect to the curved surface and the curved slope surface.

### (a) TECHNICAL FIELD OF THE INVENTION

The present invention generally relates to a slide assembly for variable transmission and power clutching, and more particularly to a slide assembly comprising a slide block that has a curved slope surface so that a roll of a driven member does not undergo undesired forced compression, which leads to damage.

### (b) DESCRIPTION OF THE PRIOR ART

Various variable transmission mechanisms are know, such as the variable transmission mechanism for power clutching as shown in FIG. 10 of the attached drawings. In the known variable transmission mechanism, a slide assembly 80 is used to function as a clutching member, which may induce a frictional force to drive the rotation of a clutch wheel 90. The slide assembly 80 comprises a slide block 81 received in a slide channel 91 defined in the clutch wheel 90. The slide block 81 forms notches 82 each comprising a slope section 83 that forms an obtuse corner portion. The slope section 83 receives a roll 84 thereon and the roll 84 is biased by a spring 85 toward the obtuse corner portion, so that when the slide block 81 moves in the slide channel 91, a surface of the roll 84 engages a curved surface 92 of the slide channel 91 and induces a frictional force therebetween so as to drive the clutch wheel 90 to rotate. However, when the roll 84 is moving toward the obtuse corner portion, due to the arrangement that the slope section 83 is inclined toward the curved surface 92, namely the distance between the slope section 83 and the curved surface 92 getting smaller and smaller, the slope section 83 and the curved surface 92 apply an acutely changing and excessively increased compressing force to the roll 84, leading to an abrupt movement of the roll 84 and causing damage of the roll due to excessive compression by the slope section 83 and the curved surface 92.

Referring to FIGS. 11 and 12, in case that the slide block 81 is not set in operation in the slide channel 91 to drive the clutch wheel 90 to rotate, when the clutch wheel 90 is kept in rotation, the roll 84 is driven by a frictional force induced by the slide channel 91 to first move toward the spring 85, and then, with the clutch wheel 90 continuously rotating, the roll 84 is forced by the spring 85 to move toward the obtuse corner portion, the roll 84 is against subjected to abrupt movement and potential risk of breaking due to excessive compression by the slope section 83 and the curved surface 92.

Thus, the present invention aims to provide a solution that protects clutching members of a variable transmission mechanism from being easily damaged and thus extends the service life of these parts.

### SUMMARY OF THE INVENTION

An objective of the present invention is to provide a slide assembly that adopts an arrangement of curved slope surface that helps protecting rolls that function for clutching operation for transmission of power from damage caused by excessive compression in a transmission device.

According to the present invention, structurally, the slide assembly comprises a slide block, which is received in a clutching channel of a driven member. The slide block forms at least one notch, which forms a curved slope surface and movably receives a roll therein. The curved slope surface has a curvature substantially identical to a curvature of a curved surface of the clutching channel, whereby the curved slope surface forms an included angle with respect to the curved surface and defines an obtuse corner portion. The roll is biased by an elastic basing member toward the obtuse corner portion. The slide block has a side surface to which a bar is mounted, and the bar carries a roller, which is movably received in a slot defined in a driving disc. As such, the roll selectively drives the driven member and when the roll is moved toward the obtuse corner portion, the curved slope surface allows the roll to maintain a constant friction pressure angle with respect to the curved surface and the curved slope surface so that no acute change and excessively increased compressing force occur between the curved surface and the curved slope surface and the roll is protected from abrupt movement and potential risk of damage due to excessive compression.

The foregoing objectives and summary provide only a brief introduction to the present invention. To fully appreciate these and other objects of the present invention as well as the invention itself', all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 a cross-sectional view showing a slide assembly according to the present invention slidably received in a clutching channel.

FIG. 2 is an exploded view of the slide assembly according to the present invention.

FIG. 3 is an exploded view showing the slide assembly of the present invention used in a transmission device.

FIG. 4 is a cross-sectional view showing the slide assembly of the present invention used in a transmission device.

FIG. 5 is a schematic view showing a roll of the slide assembly of the present invention forming identical friction pressure angle θ1 with respect to curved surfaces of the a clutch disc and curved slope surfaces of a slide block of the slide assembly.

FIG. 6 is a schematic view showing the operation of the slide assembly of the present invention.

FIG. 7 is another schematic view showing the operation of the slide assembly of the present invention.

FIG. 8 is a further schematic view showing the operation of the slide assembly of the present invention.

FIG. 9 is a cross-sectional view showing a modified embodiment of the slide assembly according to the present invention.

FIG. 10 is a schematic view showing the operation of a clutch structure of a conventional transmission device.

FIG. 11 is another schematic view showing the operation of the clutch structure of the conventional transmission device.

FIG. 12 is a further schematic view showing the operation of the clutch structure of the conventional transmission device.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

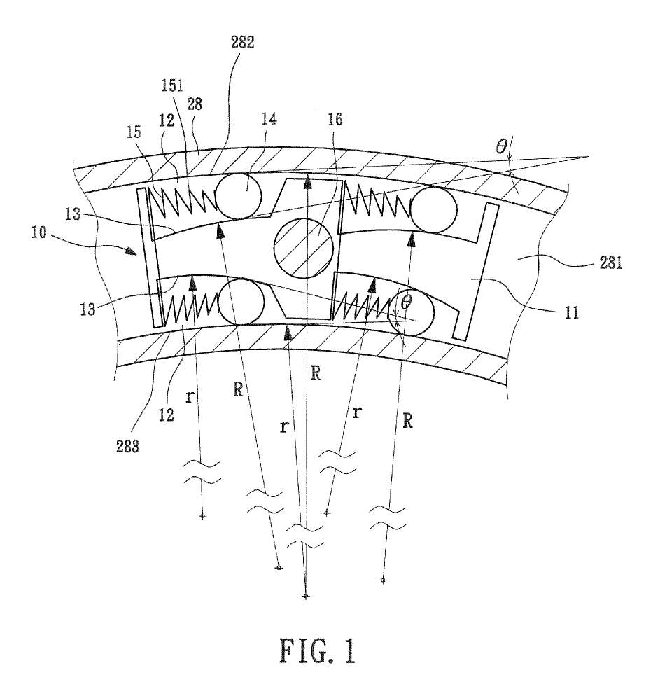

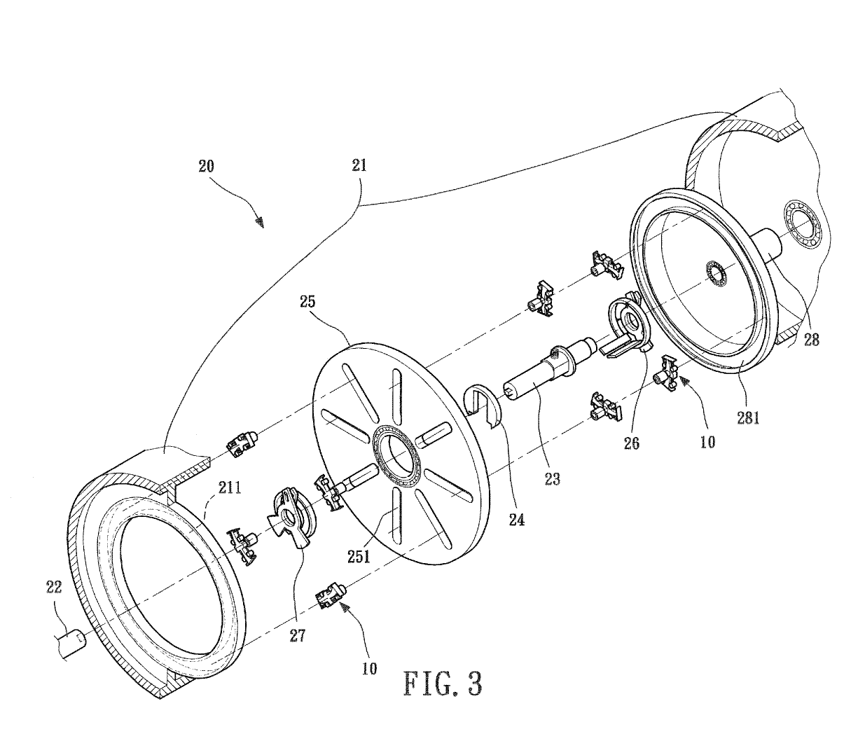

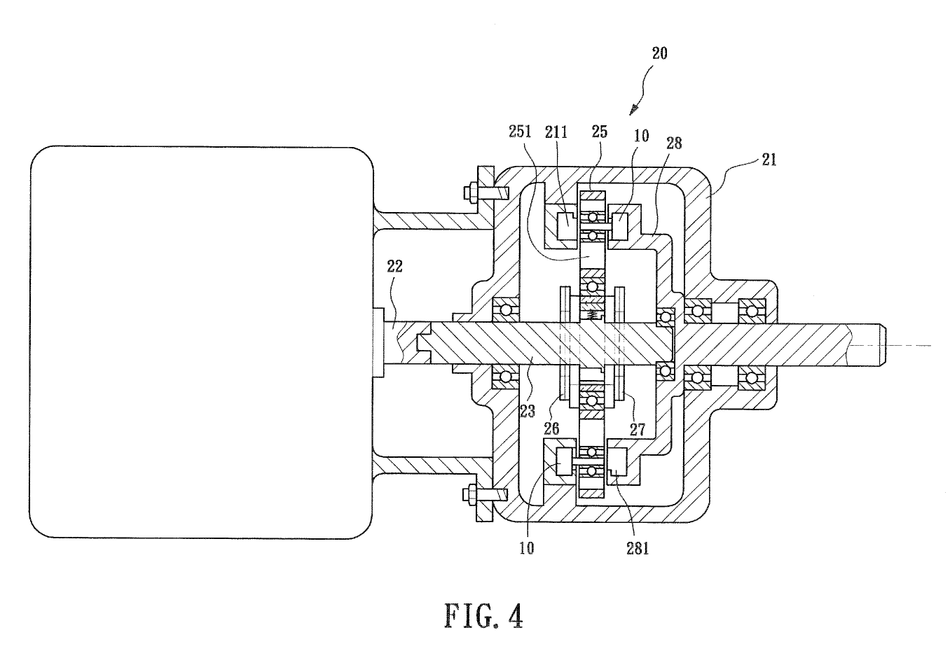

Referring to FIGS. 1, 3, and 4, the present invention provides a slide assembly 10, which is mounted in a transmission device 20. The transmission device 20 comprises a casing 21 (which is a driven member) forming a clutching channel 211, a prime mover shaft 22, an input shaft 23 coupled to the prime mover shaft 22, a centrifugal saddle 24 that is movable in a radial direction with respect to the input shaft 23 and comprises a driving disc 25, a plurality of weight assemblies 26, 27 mounted on the input shaft 23, and a clutch disc 28 (which is also a driven member) forming a clutching channel 281. A plurality of slide assemblies 10 according to the present invention is uniformly distributed on both surfaces of the driving disc 25, whereby one end of each of the slide assemblies 10 is received in a respective one of slots 251 defined in the driving disc 25, while an opposite end is received in either one of the clutching channel 211 and the clutching channel 281.

When the input shaft 23 rotates, a centrifugal force is induced and the weight assemblies 26, 27 are caused to make a radial displacement by the centrifugal force. The radial displacement of the weight assemblies causes the centrifugal saddle 24 and the driving disc 25 to move a predetermined distance in a radial distance with respect to the input shaft 23 and set in eccentric rotation to realize continuous variable transmission, which drives the clutch disc 28 or the casing 21 to rotate through the slide assemblies 10 of the present invention.

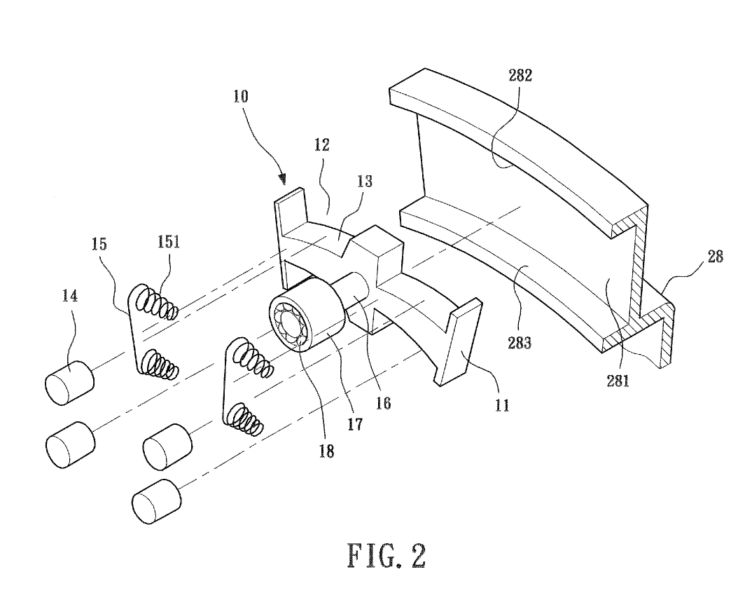

Referring to FIGS. 1, 2, and 3, the following description of the present invention is made with respect to one of the slide assemblies 10 that is received in the clutching channel 281 of the clutch disc 28, and the same is applicable to the slide assemblies 10 that are received in the clutching channel 211 of the casing 21, for they are of the same construction and operation.

The slide assembly 10 comprises a slide block 11, which is slidably received in the clutching channel 281 of the clutch disc 28. The slide block 11 forms a plurality of notches 12, and in the embodiment illustrated, two notches 12 are formed in both top and bottom of the slide block 11. Each of the notches 12 comprises a curved slope surface 13 and movably receives therein a roll 14. The notches 12 that are on the top side as viewed in FIG. 1 each have a curved slope surface 13 that has a curvature identical to a curvature of an upper curved surface 282 of the clutching channel 281. In the drawing, symbol R indicates the distance from a center of the clutch disc 28 to the upper curved surface 282 of the clutching channel 281. Also, the notches 12 that are on the bottom side as viewed in FIG. 1 each has a curved slope surface 13 that has a curvature identical to a curvature of a lower curved surface 283 of the clutching channel 281. In the drawing, symbol r indicates the distance from the center of the clutch disc 28 to the lower curved surface 283 of the clutching channel 281. Further, the curved slope surface 13 forms an included angle θ with respect to the respective curved surface 282, 283 and defines an obtuse corner portion. The roll 14 is biased by an elastic basing member 15 received in the notches 12 toward the obtuse corner portion in order to have a top surface of the roll 14 raised above the notch 12 to establish tight engagement with the clutching channel 281, whereby a frictional force induced by the engagement between the surface of the roll 14 and the clutching channel 281. The elastic basing member 15 comprises two biasing sections 151 that are spaced from but connected to each other. The biasing sections 151 are respectively received in one of the top notches 12 and the corresponding bottom notch 12. Preferably, the elastic basing member 15 is composed of compression springs, whereby the spring forces of the biasing sections 151 may respectively act on the rolls 14. The slide block 11 has a side surface to which a bar 16 is mounted. The bar 16 carries a roller 17 rotatably mounted thereon. The roller 17 is movably received in a respective one of the slots 251 of the driving disc 25. Preferably, a bearing 18 is mounted between the bar 16 and the roller 17 to facilitate easy rotation of the roller 17 and reduce the frictional resistance of the movement of the roller 17 in the slot 251, whereby the slide block 11 can be driven by the driving disc 25 to move.

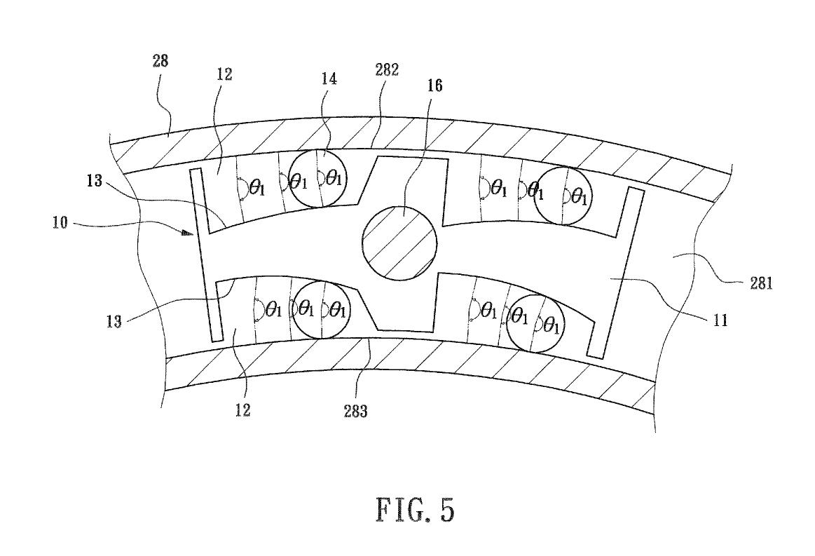

Referring to FIG. 5, according to the present invention, the curvatures of the curved slope surfaces 13 of the slide block 11 are made identical to those of the corresponding curved surfaces 282, 283 of the clutching channel 281. When the roll 14 moves within the notch 12 toward the obtuse corner portion, the curved configuration of the curved slope surface 13 helps maintaining the friction pressure angle θ1 of the roll 14 between the curved surface 282, 283 and the curved slope surface 13 substantially constant.

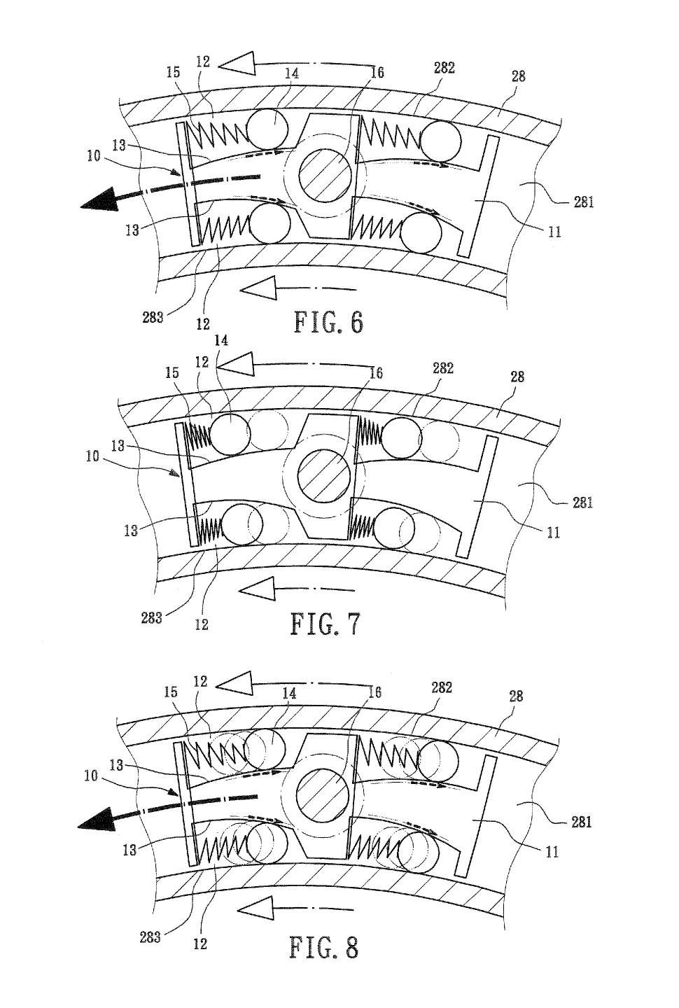

Referring FIG. 6, when the slide assembly 10 according to the present invention is driven by the driving disc 25 to move, the roll 14 is biased by the elastic basing member 15 to move toward the obtuse corner portion of the notch 12, and a frictional force is induced to drive the clutch disc 28 to rotate. With the curved configuration of the curved slope surface 13, no excessively increased compressing force may be induced between the curved surface 282, 283 and the curved slope surface 13 and the roll 14 is prevented from being damaged due to the excessive compression.

Referring to FIGS. 7 and 8, from what shown in FIG. 6, in case that the slide assembly 10 according to the present invention is not set in an operation condition that drives rotation of the clutch disc 28, when the clutch disc 28 maintains rotating (namely, the clutching channel 281 being still in rotation), due to friction, the clutching channel 281 may first drive the roll 14 to move toward and thus compress the elastic basing member 15, and subsequently, the spring force of the compressed elastic basing member 15 forces the roll 14 to move toward the obtuse corner portion of the notch 12. With the arrangement of the curved configuration of the curved slope surface 13, no acute change and excessively increased compressing force may occur between the curved surface 282, 283 and the curved slope surface 13, so that the roll 14 is prevented from being damaged due to the excessive compression. As such, the present invention provides an advantage of being not easily damaged and the service life can thus be extended.

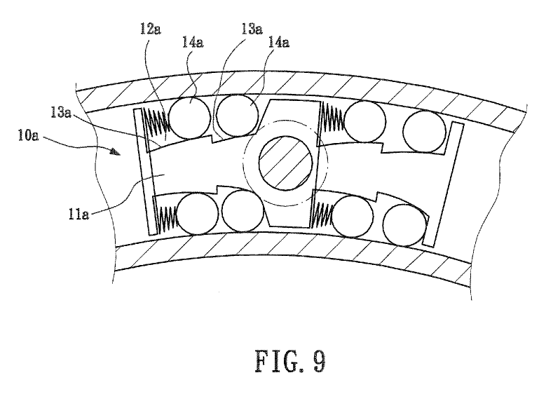

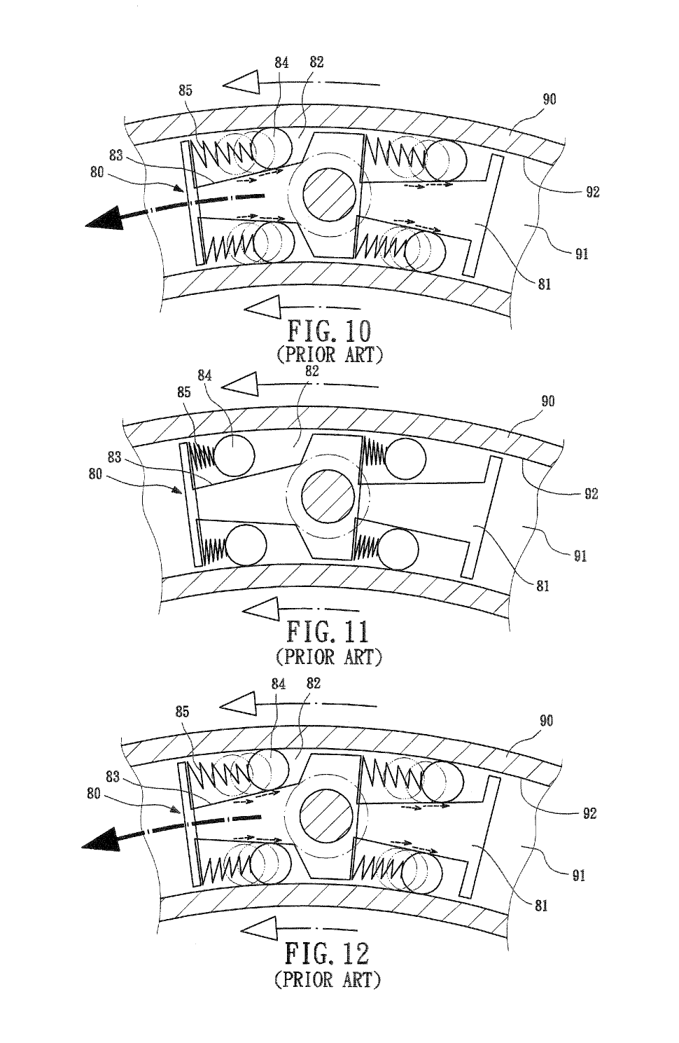

Referring to FIG. 9, a modified embodiment of the present invention is shown, wherein the present invention provides a slide assembly 10a that comprises a slide block 11a forming notches 12a each forming a plurality of curved slope surfaces 13a and movably receiving therein a plurality of rolls 14a. An example as shown in the drawing comprises two curved slope surfaces 13a and two rolls 14a for each of the notches.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A slide assembly, which is adapted to use in a transmission device to enhance clutching operation for transmission of power, the slide assembly comprising a slide block, which is received in a clutching channel of a driven member, the slide block forming at least one notch, which forms a curved slope surface and movably receives a roll therein, the curved slope surface having a curvature substantially identical to a curvature of a curved surface of the clutching channel, whereby the curved slope surface forms an included angle with respect to the curved surface and defines an obtuse corner portion, the roll being biased by an elastic basing member toward the obtuse corner portion, the slide block having a side surface to which a bar is mounted, the bar carrying a roller, which is movably received in a slot defined in a driving disc, whereby the roll selectively drives the driven member and when the roll is moved toward the obtuse corner portion, the curved slope surface allows the roll to maintain a constant friction pressure angle with respect to the curved surface and the curved slope surface so that no acute change and excessively increased compressing force occur between the curved surface and the curved slope surface and the roll is protected from abrupt movement and potential risk of damage due to excessive compression.

2. The slide assembly according to claim 1, wherein the elastic basing member comprises a spring.

3. The slide assembly according to claim 1, wherein the notch is formed in a top of the slide block and the curved slope surface of the notch has a curvature identical to a curvature of an upper curved surface of the clutching channel.

4. The slide assembly according to claim 1, wherein the notch is formed in a bottom of the slide block and the curved slope surface of the notch has a curvature identical to a curvature of a lower curved surface of the clutching channel.
